(19) United States
(12) Patent Application Publication
(10) Pub. No.: US 2012/0015322 A1
(43) Pub. Date: Jan. 19, 2012

(54) TOOTH WHITENING II

(76) Inventors: Geoffrey Morgan Lloyd, Sandhurst (GB); Cormac John Devery, Surrey (GB)

(21) Appl. No.: 13/139,811

(22) PCT Filed: Dec. 17, 2009
(86) PCT No.: PCT/GB09/02909

§ 371 Date: Sep. 30, 2011

(30) Foreign Application Priority Data
Dec. 23, 2008 (GB) 0823435.3
Mar. 11, 2009 (GB) 0904164.1

(51) Int. Cl. A61C 17/00

(52) U.S. Cl. 433/80; 433/215

(57) ABSTRACT

A method of cosmetically whitening teeth in vivo comprises exposing the teeth to be whitened to a flow of non-thermal gaseous plasma at a temperature acceptable for oral administration of the non-thermal gaseous plasma and for a time sufficient for the non-thermal gaseous plasma to have a tooth-whitening effect. Repeated treatments may be performed. The non-thermal gaseous plasma may be formed of helium or a mixture of helium and oxygen.

This invention relates to a method of treatment particularly a method for the cosmetic whitening of teeth. The term “whitening” as used herein includes stain removal within its scope.

The staining or discolouration of teeth has a number of causes.

Extrinsic discolouration arises when external chromogens (substances which are readily converted into dyes or pigments) are deposited on the tooth surface or within the pellicle layer of the tooth. Extrinsic stains may be caused by poor oral hygiene, plaque stuck on teeth can turn yellow. Drinks such as tea, coffee, red wine and colas as well as berries, curry and fried foods are a source of the chromogens.

Extrinsic staining affects the surface of the teeth so it is relatively straightforward to remove using a thorough oral hygiene programme of brushing and flossing.

Intrinsic discolouration occurs within the structure of the tooth when the chromogens are deposited within the bulk of the tooth, usually in the dentine and are often of systemic or pulpal origin.

A third category of ‘stain internalisation’ has recently been described to include those circumstances where an extrinsic stain enters the tooth through defects in the tooth structure.

Tooth discolouration creates a wide range of cosmetic problems and the dental profession and the public expend considerable amounts of time and money in attempts to improve the appearance of discoloured teeth.

The methods available to manage discoloured teeth range from removal of surface stain, bleaching or tooth whitening techniques and operative techniques to camouflage the underlying discolouration, such as veneers and crowns.

Whitening toothpaste often has a semi solid state such as a gel or a paste. These products contain abrasive agents such as silica, aluminium oxide, calcium carbonate, or calcium phosphate to grind off extrinsic stains.

Such toothpastes are not, however, able to alleviate intrinsic discolouration of teeth. Accordingly, chemical treatments are practised to cause degradation or decomposition of the chromogens.

A common whitening agent is peroxide. Strips and trays are often used to apply peroxide for a period longer than that achievable using typical tooth brushing. Concentrations of the whitening active whitening compound, contact time and number of applications are key parameters to determine the effectiveness of whitening.

Commercially, it is most desirable to increase the whitening efficiency of products to deliver a more satisfying product experience. Increasing the concentration of peroxide, generally results in faster whitening. However, increasing the concentration of the peroxide in the whitening composition can produce tooth sensitivity and cause soft tissue irritation particularly in the gums.

High concentrations of peroxide may require a physical barrier to prevent the peroxide from contacting and burning the soft tissue thereby making the use of high peroxide concentrations very inconvenient and impractical for unsupervised home use. Such technologies are particularly unsuitable for repeated use.

A large number of alternative chemical approaches have therefore been investigated.

U.S. Pat. No. 6,770,266 discloses a liquid tooth whitener based on polyethylene oxide. This tooth whitener has the advantage of convenience of use and little unnatural feeling. However, the polyethylene oxide is water soluble and thus adheres to the teeth poorly. Consequently, absorption of peroxide to the teeth is insufficient and the whitening effects required by consumers are not achieved.

U.S. Pat. No. 6,569,408 discloses a liquid tooth whitener using an organosiloxane resin. This is convenient to use and does have good adhesion to teeth and can be used overnight. However, the key disadvantage is that the use of a non-hydrophilic polymer militates against adsorption of peroxide as a whitening agent.

U.S. Pat. No. 6,555,020 discloses a tooth whitening liquid comprising polyacrylic acid. However, the tooth whitening gel is easily diluted by saliva, causing poor adhesion to teeth. Furthermore, whitening reactions on the surface of the tooth are retarded by the addition of peroxide stabiliser (EDTA or similar), which makes it difficult to obtain desired teeth whitening effects.

US 2003082500 discloses a method and apparatus using ozone to whiten teeth. The ozone is believed to react in the mouth to form peroxide. The method does, however, involve exposing the person being treated to an undesirably high concentration of ozone.

There is therefore a need for improved methods of whitening teeth.

According to the present invention there is provided a method of cosmetically whitening teeth in vivo, comprising exposing the teeth to be whitened to a flow of non-thermal gaseous plasma at a temperature acceptable for oral administration of the non-thermal gaseous plasma and for a time sufficient for the non-thermal gaseous plasma to have a tooth-whitening effect.

The invention also provides a cosmetic kit for the whitening of teeth comprising a generator of a non-thermal gaseous plasma, the non-thermal gaseous plasma being suitable for oral administration, a device for the oral administration of the non-thermal gaseous plasma, and a set of instructions in a suitable medium for the use of the kit to whiten teeth.

The instructions may be in writing or in another medium, for example, a computer program or digital video disc.

The non-thermal gaseous plasma may be generated by any method known in the art. The non-thermal gaseous plasma preferably enters the mouth at a temperature in the range of 10 to 40° C. Higher temperatures up to, for example, 55° C. may be used but care must be taken in the design of the plasma generator not to employ so high a temperature as would burn the mouth of the person being treated. In general, non-thermal plasma are not able to be produced below the ambient temperature when cooling is applied to the gaseous plasma after its generation.

During one treatment, each tooth may be subjected to the non-thermal gaseous plasma for a period of at least 10 second and typically up to a minute at a time. Repeated or cumulated treatments may be applied, particularly to tackle deep-seated stains. For example, the treatment may be applied every day for a period of a month or longer.

The non-thermal gaseous plasma may be generated by any method known in the art. For example, a method according to WO-A-2006/096 716 may be used. Such a method employs an atmospheric dielectric-barrier discharge to generate the non-thermal gaseous plasma. Such methods use plasma generators that are capable of miniaturisation. See “Atmospheric Dielectric-Barrier Discharges Scalable from 1 mm to 1 m”, James L Walsh et al, IEEE Transactions on Plasma Science, Vol 36, No 4, August 2008.

Unipolar nano-second-square voltage pulses at repetition rates in the 1-10 kHz range may be used in the generation of the non-thermal gaseous plasma. This enables the non-thermal gaseous plasma to be produced in the form of a series of packets or bullets. Employing such a pulsed voltage source facilitates production of the non-thermal gaseous product at a temperature suitable for oral administration of the plasma.

The non-thermal gaseous plasma includes ions, electrons and excited species. These species react with air in the mouth to form, we believe, a cocktail of reactive species, including hydroxyl radicals, that will react with chromogens and/or stains in or on the teeth of the person being treated. It is therefore not necessary that the gas stream which is sent to the plasma generator contain oxygen, although if desired it might include oxygen as one of its components. Typically, the gas stream comprises a noble gas, helium being preferred because it is found that for a given plasma generator, helium is more readily converted into a plasma than other gases, and therefore the temperature of a non-thermal gaseous plasma of helium will be less than for other gases. Alternatively other noble gases such as neon, argon, krypton or xexon may be used instead or in addition to helium.

If desired, the gas from which the non-thermal gaseous plasma is formed may comprise a mixture of 75-100% by volume of noble gas (particularly helium) and 0-25% by volume of oxygen. Another alternative is a mixture of the noble gas and air.

The non-thermal gaseous plasma may be applied through a tube which communicates at one of its ends with the plasma generator and has its other end open and of a configuration that permits it to be inserted into the mouth and moved over the teeth that are to be whitened. The tube may be connected to the plasma generator through a hose or other flexible coupling.

The flow rate of the gas from which the non-thermal gaseous plasma is formed is not critical to the method according to the invention. It is desirable, however, to minimise the flow rate of the gas so as to keep down its rate of consumption. A gas flow rate in the range of 5 ml/minute to 50 ml/minute is suitable.

The gas may be supplied from a gas cylinder in which it is stored under pressure. If a gas mixture is used as the gas from which the non-thermal gaseous plasma is formed, the components of the gas mixture can be supplied from separate cylinders and mixed in a gas mixer to form the desired composition. Alternatively, the gas mixture may be pre-packaged in a single gas cylinder.

The method according to the invention may be employed to extrinsic or intrinsic tooth stains, or both of these.

If desired, the mouth may be irrigated prior to performing the method according to the invention.

In a non-thermal gaseous plasma electrons are excited by the application of an electrical field to the gas. These electrons are reactive species and will react in the mouth with oxygen molecules and water molecules to produce further reactive species including, we believe, hydroxyl/radicals which can react with each other to form peroxide. The method according to the invention is thus able to form reactive species which are effective tooth whiteners, but in relatively low concentrations so that discomfort is not caused to the person whose teeth are being whitened. Further by applying a non-thermal gaseous plasma directly to the teeth being whitened, the desirable reactive species can be formed in the vicinity of the teeth themselves.

The method according to the present invention will now be described, by way of example, with reference to the accompanying drawings in which

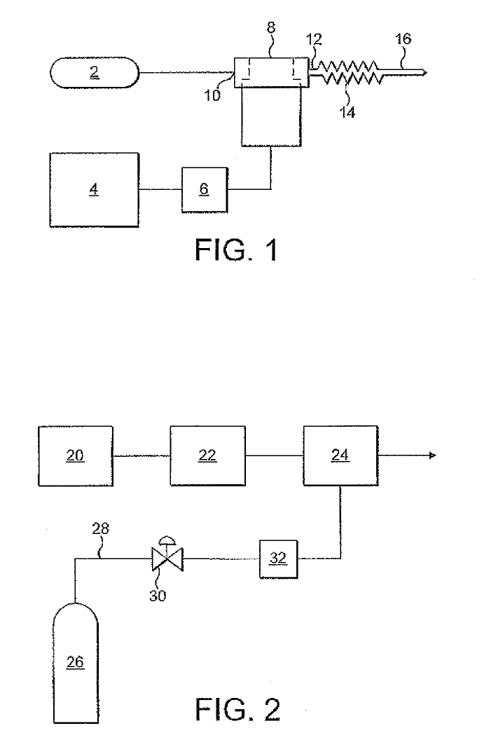

FIG. 1 is a schematic drawing of a non-thermal gaseous plasma generator connected to a tube for applying the plasma to a person's mouth.

FIG. 2 is a schematic flow diagram of an experimental apparatus for whitening teeth.

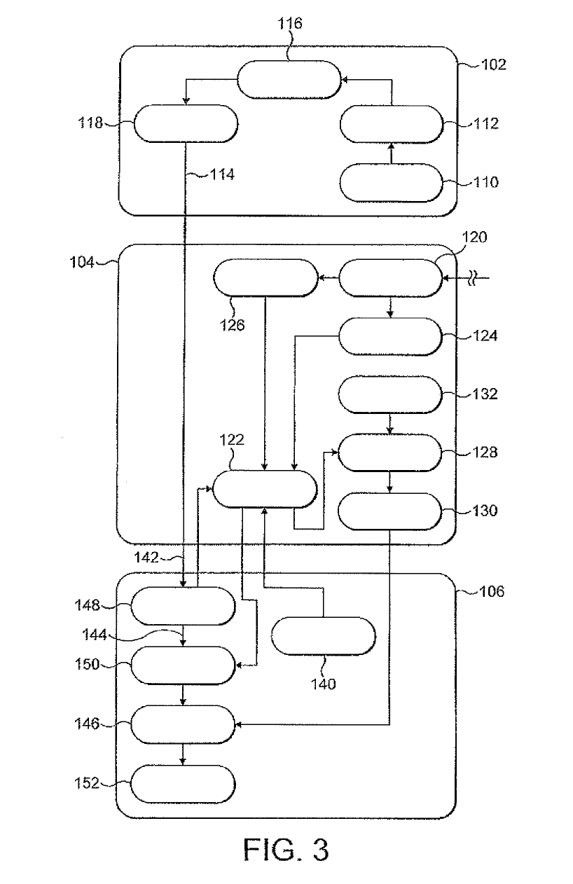

FIG. 3 is a schematic flow diagram of an alternative experimental apparatus for whitening teeth.

The drawings are not to scale.

The apparatus shown in FIG. 1 of the drawing includes a gas cylinder 2 containing under pressure a gas or gas mixture from which a non-thermal gaseous plasma is formed. The apparatus also includes a power source 4. The power source 4 may be an AC or DC voltage source. It is operatively associated with a signal generator 6 adapted to connect the voltage generated by the power source 4 into a suitable pulsed form. See the papers referred to above and WO-A-2004/016052. The apparatus also includes a plasma generating cell 8 comprising a pair of electrodes (not shown) across which the pulsed voltage is generated by the signal generator 6 is applied. The plasma generating cell 8 may have any convenient configuration, for example, that described in WO-A-2006/096718. Application of the pulsed voltage across the electrodes of the cell 8 causes a non-thermal gaseous plasma to be formed. The cell 8 is operated at atmospheric pressure and has an inlet 10 able to be placed in communication with the gas cylinder 2. Gas can thus be passed continuously into the cell from the gas cylinder. The non-thermal gaseous plasma is thus formed from the gas that is stored under pressure in the gas cylinder 2. The cell 8 has an outlet 12 for the non-thermal gaseous plasma. The outlet 12 is connected through a flexible hose 14 to an applicator tube 16. The person whose teeth are to be whitened can therefore insert the tube 16 into his or her mouth and apply the non-thermal gaseous plasma to each tooth, back and front, in turn. Typically, each tooth is treated for at least 10 seconds with the non-thermal gaseous plasma. Alternatively, the treatment can be performed by a dentist or dental hygienist.

The above described apparatus may be provided with instructions for use in tooth whitening.

The method according to the invention will now be further illustrated by the following example.

### EXAMPLE

A non-thermal gaseous plasma was created employing the apparatus shown in FIG. 2. This apparatus employed an adjustable DC power supply 20 electrically connected to a high voltage generator 22 (otherwise known as an HV Plasma Driver) for generating AC power supply to a non-thermal plasma generator 24. The apparatus shown in FIG. 2 also included a cylinder 26 of compressed helium, a conduit 28 leading from the cylinder 26 to the interior of the non-thermal plasma generator 24. The conduit 28 was provided with a pressure regulator 30 and a flowmeter 32.

The DC power supply 20 was a commercially—available SKYTRONIC 650.682 Adjustable DC Power Supply. The high voltage generator 22 was a commercially—available PVM 12 “Variable High Voltage High Frequency Single Ended Plasma Driver” supplied by Information Unlimited, PO Box 716, Amhurst, N.H., USA. The non-thermal plasma generator 24 was laboratory-built, having a tubular confirmation with a tubular transparent housing providing a tubular plasma chamber having an internal diameter of 6 mm. Further, the non-thermal plasma generator 24 was of a single dielectric, needle kind. A flow of gaseous plasma was discharged from the distal end of the generator 24 and directed at the tooth to be treated.

In operation, the flow rate of helium to the non-thermal plasma generator 24 was 1.5 l/minute, the voltage provided across the electrodes (not shown) of the non-thermal plasma generator was 1.6 kV, rms, at a frequency of 50 kHz. The chamber of the non-thermal plasma generator was operated at approximately atmospheric pressure (i.e. approximately 1 bar). A non-thermal plasma core of 1.5 to 2 cm was produced to apply to sample teeth.

A total of nine excisor and molar teeth were extracted from young pigs. Six were selected for treatment in accordance with the invention and three for control samples. The colour of the teeth was assessed before and after treatment according to the invention (or according to the control procedure in the case of the control samples). For this purpose, a Vita shade guide was used to assess the colour of the enamel of the teeth. This guide allocates the letters A to D to different hues—e.g. greys/yellows/reds/browns. Categories “A” and “B” are considered by those skilled in the art as being as good as each other and superior to “C” and “D”. The numbers 1 to 4 provide a progressively declining scale of brightness with 1 being the brightest and 4 the dullest.

The clinician testing the teeth was blinded to which of the nine teeth had been treated in accordance with the invention and which were control samples. The shade of each tooth was assessed immediately before and immediately after the treatment. The teeth were examined under magnification with a neutral light used clinically for examining teeth when selecting shades prior to manufacturing crowns of placing fillings.

The treatment procedure was as follows:
a) the teeth were extracted from a freshly sacrificed pig's jaw;
b) the teeth were moistened with water and maintained moist throughout the treatments;
c) the shade of each moistened tooth was assessed;
d) six moistened teeth (Nos. 1-6) were each treated one at a time for five minutes with the non-thermal helium plasma, the treatment requiring the plasma core to be incident on the teeth; one other moistened tooth (No. 10) was subjected to treatment with unexcited helium for five minutes; while the final two teeth (Nos. 11 and 12) were not subjected to any treatment;
e) the shade of each tooth was then reassessed;
f) the teeth were then left to stand for one hour;
g) steps (d) and (e) were then repeated;
h) the teeth were then left to stand for a further hour;
i) step (d) and (e) were then repeated again.
   The results of the shade assessments are given in the Table below.

VITA SHADE RESULTS

| Tooth | Pre- | After 1^{st} | After 2^{nd} | After 2^{nd} |
|---|---|---|---|---|
| Number | treatment | Treatment | Treatment | Treatment |
| 1 | A2 | A2 | A2 | A2 |
| 2 | C2 | A1 | A1 | A1 |
| 3 | C3 | B2 | B2 | B1 |
| 4 | A2 | A2 | B2 | B2 |
| 5 | C3 | B2 | A2 | A2 |
| 6 | D2 | B1 | B1 | B1 |
| 10 (ctl gas) | B3 | A3 | B3 | B3 |
| 11 (ctl NT) | B3 | A3 | B3 | B3 |
| 12 (ctl NT) | C3 | C3 | C3 | C3 |

NT: No treatment
Gas: Unexcited helium

It was noted that teeth 1 and 4 were quite light in shade before the treatment. With the exception of those two teeth, all the teeth treated according to the invention underwent as a result of the first treatment with non-thermal helium plasma a favourable change of shade. Repeating the treatment did not appear to increase the change of shade, although it was difficult to reach a firm conclusion on this in the light of the sample size. As in conventional treatments, the change in shade did not appear to be permanent: it was observed that a few hours after the completion of the experiments, tooth shade did appear to be returning to the original colour.

It was also observed, but not quantified, that areas of surface staining were also removed from the enamel of the teeth treated in accordance with the invention.

Referring now to FIG. 3, a non-thermal plasma generating apparatus comprises a gas supply unit 102, an electrical signal generating unit or means 104, and a handheld plasma generator unit 106.

The gas supply 102 comprises a small (one litre water capacity) cylinder 110 containing compressed helium under a pressure of 200 bar. The cylinder 110 is fitted with a valve 112 of a kind containing an integral pressure regulator which reduces the pressure of gas drawn from the cylinder 110 to 8 bar gauge. The valve 112 communicates with a heavy duty flexible hose 114 providing a path for the flow of helium gas from the cylinder 110 to the plasma generator unit 106. The hose 114 had disposed therealong a flow control valve 116 to enable the rate of flow of helium to the plasma generator unit 106 to be adjusted, and a pressure regulator 118 which is set to deliver helium to the plasma generator 106 at a pressure of 0.5 bar gauge (1.5 bar absolute).

The signal generation unit 104 is essentially a device for converting a 12V DC signal into a 6 kV AC plasma driving signal for generating the non-thermal plasma. In addition, the unit 104 provides a microcontroller for controlling the gas supply to the plasma generator unit 106. The signal generator 104 comprises a 12V rechargeable battery 120 associated with a main on/off switch 124 for powering up a logic circuit 122. The logic circuit 122 is, as shall be described below, used to ensure that the plasma generator operates only in certain circumstances. The battery 120 also has associated with it a monitor 126 for displaying a low battery power condition. Depression of the switch 124 causes the logic circuit 122 to initiate operation of a low voltage signal generator 128 able to generate a pulsed low voltage AC signal from a DC voltage source and to transmit the signal to a high voltage signal generator 130. The signal generator 130 is able to produce a pulsed AC signal of 6 KV, the pulses being produced on a 15% duty cycle, i.e. for 85% of its operating time the generator means 130 produces no signal. The voltage and frequency of the signal produced by the signal generator 130 is controlled by means of voltage/frequency control circuits 132. The arrangement is such that the signals are produced by the generator 130 only if the main switch 124 is on and the logic circuit 122 indicates that the gas is flowing to the plasma generator unit 106.

The handheld plasma unit 106 has an on-off switch 140 which when in its “on” position, causes a signal from the logic circuit 122 to activate a solenoid valve 150, as shall be described below. The arrangement is such that the plasma generator is operated only when the switch 140 is in its “on” position. The unit 106 has a gas inlet 142 connectable to the hose 114. The gas inlet 142 leads to a passage 144 leading to a plasma generator cell 146. The cell 146 had a pair of spaced apart electrodes (not shown), both acting through quartz dielectrics (not shown). The high voltage signal from the signal generator 130 is applied across the electrodes of the cell 146. The arrangement is, however, that no such voltage is applied until a predetermined time after a flow sensor 148 in the passage 144 transmits a signal to the logic circuit 122, the circuit 122 enabling the high voltage signal to be generated by the generator 130 only after a predetermined time delay. Operation of the switch 140 to place it in its “on” position enables the logic circuit 122 in the unit 104 to send a signal to open a solenoid valve 150 at the inlet to the plasma generator cell 146. Opening of a solenoid valve 150 causes helium to be admitted to the plasma cell 146, the helium flowing therethrough to an applicator 152. The unit 106 is held in an operator's hand so as to direct the non-thermal helium plasma at a chosen target.

In operation the helium cylinder 110 may contain helium of 99.9999% purity.

A method of cosmetically whitening teeth in vivo comprising exposing the teeth to be whitened to a flow of non-thermal gaseous plasma at a temperature acceptable for oral administration of the non-thermal gaseous plasma and for a time sufficient for the non-thermal gaseous plasma to have a tooth-whitening effect.

What is claimed is:

1. A method according to claim 1, wherein the non-thermal gaseous plasma enters the mouth at a temperature in the range of 10-to 40° C.

2. A method according to claim 1, wherein the non-thermal gaseous plasma is applied to each tooth to be treated for a period of at least 10 seconds at a time.

3. A method according to claim 1, wherein the tooth-whitening effect is produces cumulatively.

4. A method according to claim 1, wherein the non-thermal gaseous plasma is generated by an atmospheric dielectric barrier discharge.

5. A method according to claim 1, wherein unipolar nanosecond square voltage pulses at repetition rates in the range of 1 to 10 kHz are used to generate the non-thermal gaseous plasma.

6. A method according to claim 1, wherein the said gas comprises a noble gas.

7. A method according to claim 7, wherein the noble gas is helium.

8. A method according to claim 1, wherein the said gas includes a mixture of the noble gas and oxygen.

9. A method according to claim 9, wherein the said gas is a mixture of 75% to 100% by volume of helium and 0 to 25% by volume of oxygen.

10. A method according to claim 7, wherein the said gas is free of oxygen.

11. A method according to claim 1 in which the non-thermal gaseous plasma is generated at atmospheric pressure.

12. A method according to claim 1, wherein the non-thermal gas plasma is applied to teeth, in vivo, from a tube which communicates at one of its ends with the plasma generator and has its other end open and of a configuration that permits to be inserted in the mouth and moved over the teeth that are to be whitened.

13. A method according to claim 1, wherein the flow rate of the gas from which the non-thermal gaseous plasma is formed is in the range of 5 to 50 ml/minute.

14. A method according to claim 1, wherein the method is used to whiten teeth that have extrinsic stains.

15. A method according to claim 1, wherein the method is used to whiten teeth that have intrinsic stains.
